(19) United States
(12) Patent Application Publication
(10) Pub. No.: US 2022/0414752 A1
(43) Pub. Date: Dec. 29, 2022

(54) CONTROL APPARATUS, METHOD, AND STORAGE MEDIUM

(71) Applicant: TOYOTA JIDOSHA KABUSHIKI KAISHA, Aichi-ken (JP)

(72) Inventors: Yu NAGATA, Tokyo (JP); Kazutaka KIMURA, Mishima-shi (JP); Tomokazu MAYA, Nagoya-shi (JP); Tsuyoshi NISHIOKA, Toyota-shi (JP); Takaharu TATEISHI, Nagoya-shi (JP); Yuki YAMASHITA, Tokyo (JP)

(21) Appl. No.: 17/743,380

(22) Filed: May 12, 2022

(30) Foreign Application Priority Data
Jun. 29, 2021 (JP) 2021-107908

(51) Int. Cl. G06Q 30/06; G01C 21/34

(52) U.S. Cl. CPC G06Q 30/0639; G01C 21/343; G01C 21/3453; G06Q 30/0235

(57) ABSTRACT

A control apparatus includes a control section that acquires itinerary information indicating a route on which a vehicle travels, the route including a departure point, a destination, and a waypoint that enables charging of the vehicle, and a first departure time for the vehicle to depart from the departure point, and that based on the itinerary information, sets a second departure time resulting from the first departure time being modified such that a time of arrival of the vehicle at the waypoint becomes a predetermined time.

### CROSS-REFERENCE TO RELATED APPLICATION

This application claims priority to Japanese Patent Application No. 2021-107908 filed on Jun. 29, 2021, incorporated herein by reference in its entirety.

### BACKGROUND

### 1. Technical Field

The disclosure relates to a control apparatus, a method, and a storage medium.

### 2. Description of Related Art

Conventionally, techniques relating to a plan for replenishment of energy for a vehicle have been known. For example, Japanese Unexamined Patent Application Publication No. 2012-002778 discloses that in a navigation system, setting a schedule of use at a charging spot and a route to a destination in such a manner as to prevent a timing for a subject vehicle to use the charging spot from coinciding with that of another vehicle. For example, Japanese Unexamined Patent Application Publication No. 2009-008609 describes recommending a facility for energy replenishment in consideration of a charging fee varying by time slot.

### SUMMARY

There has been no encouragement to urge users to actively replenish energy when a cost for energy replenishment is low, and thus, the techniques relating to a plan for replenishment of energy for a vehicle have room for improvement.

An object of the present disclosure made in view of such circumstances is to improve a technique relating to a plan for replenishment of energy for a vehicle.

A control apparatus according to an embodiment of the present disclosure includes a control section that acquires itinerary information indicating a route on which a vehicle travels, the route including a departure point, a destination, and a waypoint that enables charging of the vehicle, and a first departure time for the vehicle to depart from the departure point, and that based on the itinerary information, sets a second departure time resulting from the first departure time being modified such that a time of arrival of the vehicle at the waypoint becomes a predetermined time.

A method according to an embodiment of the present disclosure includes: acquiring itinerary information indicating a route on which a vehicle travels, the route including a departure point, a destination, and a waypoint that enables charging of the vehicle, and a first departure time for the vehicle to depart from the departure point, and based on the itinerary information, setting a second departure time resulting from the first departure time being modified such that a time of arrival of the vehicle at the waypoint becomes a predetermined time.

A storage medium according to an embodiment of the present disclosure stores a program for making a computer execute an operation including: acquiring itinerary information indicating a route on which a vehicle travels, the route including a departure point, a destination, and a waypoint that enables charging of the vehicle, and a first departure time for the vehicle to depart from the departure point, and based on the itinerary information, setting a second departure time resulting from the first departure time being modified such that a time of arrival of the vehicle at the waypoint becomes a predetermined time.

An embodiment of the present disclosure improves a technique relating to a plan for replenishment of energy for a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a flowchart illustrating operation of a control apparatus according to the embodiment of the present disclosure;

FIG. 3 is a diagram for describing a route included in itinerary information according to the embodiment of the present disclosure;

FIG. 4 is a diagram illustrating an example of unit price information according to the embodiment of the present disclosure;

FIG. 5 is a flowchart illustrating operation of a control apparatus according to a first modification;

FIG. 6 is a diagram illustrating unit price information according to the first modification;

FIG. 7 is a flowchart illustrating operation of a control apparatus according to a second modification;

FIG. 8 is a diagram for describing a route included in itinerary information according to the second modification;

FIG. 9 is a diagram illustrating an example of pieces of waypoint unit price information according to the second modification; and

FIG. 10 is a flowchart illustrating operation of a control apparatus according to a third modification.

### DETAILED DESCRIPTION OF EMBODIMENTS

An embodiment of the disclosure will be described below.

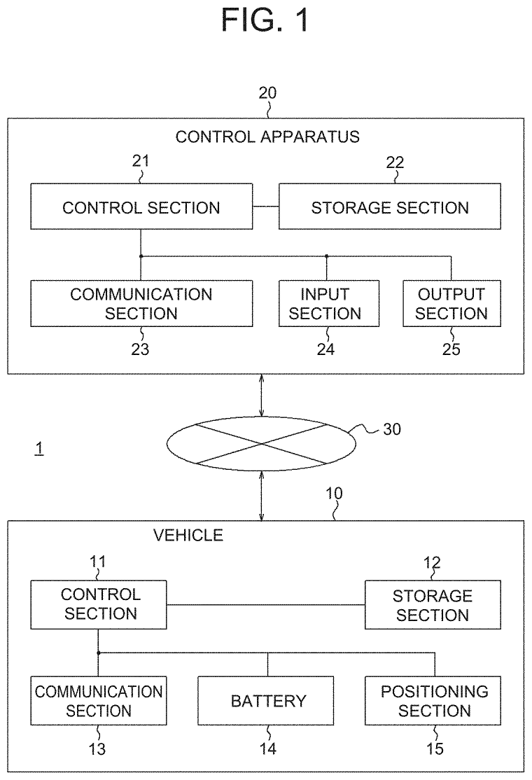

An overview of a system 1 according to an embodiment of the present disclosure will be described with reference to FIG. 1. The system 1 includes a vehicle 10 and a control apparatus 20. The vehicle 10 and the control apparatus 20 are communicably connected to a network 30 including, for example, the Internet and a mobile communication network, or the like.

The vehicle 10 is, for example, an automobile, but is not limited to this example and may be any vehicle that runs on charged electricity. Examples of the vehicle include, but are not limited to, a battery electric vehicle (BEV), a hybrid electric vehicle (HEV), and a plug-in hybrid electric vehicle (PHEV). The number of vehicles 10 included in the system 1 may arbitrarily be determined.

The control apparatus 20 is, for example, a computer such as a server apparatus. The control apparatus 20 can communicate with the vehicle 10 via the network 30.

First, an overview of the present embodiment will be described and details will be described later. The control apparatus 20 acquires itinerary information indicating a route on which the vehicle 10 travels, the route including a departure point, a destination, and a waypoint that enables charging of the vehicle 10, and a first departure time for the vehicle 10 to depart from the departure point. Based on the itinerary information, the control apparatus 20 sets a second departure time resulting from the first departure time being modified such that a time of arrival of the vehicle 10 at the waypoint becomes a predetermined time.

The “departure point” refers to a particular spot from which the vehicle 10 starts travelling toward a destination. Examples of “departure point” include a user's home and company, the user taking a drive in the vehicle 10. The departure point may be a current position of the vehicle 10. The “destination” refers to a particular spot that the vehicle 10 is intended to visit. Examples of “destination” include a sightseeing spot. Examples of “departure point” and “destination” are not limited to these examples, and if the user taking a drive in the vehicle 10 intends to travel home from a sightseeing spot, the sightseeing spot is a “departure point” and the home is a “destination”. The “waypoint” refers to a particular spot at which the vehicle 10 can stop off during a travel to a destination, the spot being equipped with a charging facility that enables charging of the vehicle 10. The “first departure time” refers to a departure time set in advance before the vehicle 10 departs for a destination. The first departure time may be set by the user. As described below, the “second departure time” is one set by the control apparatus 20 via modification of the first departure time based on itinerary information.

The “itinerary information” includes a route including a departure point, a destination, and a waypoint, and the first departure time. The “itinerary information” may be generated via an arbitrary method. For example, the control apparatus 20 first communicates with a terminal device the user uses, and receives information indicating a departure point, a destination, and a departure time input to the terminal device by the user. The control apparatus 20 determines a route from the departure point to the destination based on the information. Furthermore, the control apparatus 20 determines at least one arbitrary waypoint on the route. The control section 21 determines the received departure time as the first departure time. The control apparatus 20 may generate itinerary information including the received departure point and destination, and the determined waypoint and the first departure time to acquire the itinerary information.

As described above, the present embodiment enables modifying the vehicle 10's departure time once set, such that a time of arrival at a waypoint at which the vehicle 10 stops off for charging is included in a desired time slot. The control apparatus 20 proposes a modified departure time to the user. The user can arrive at the waypoint in a time slot in which a cost for charging is low, by departing at the proposed departure time. As described above, it is possible to urge a user to replenish energy when a cost for energy replenishment is low. Therefore, it is possible to improve a technique relating to a plan for replenishment of energy for the vehicle 10.

Next, components of the system 1 will be described in detail.

As illustrated in FIG. 1, the vehicle 10 includes a control section 11, a storage section 12, a communication section 13, a battery 14, and a positioning section 15. The control section 11, the storage section 12, the communication section 13, and the battery 14 may be communicably connected to, for example, an in-vehicle network such as a controller area network (CAN).

The control section 11 includes one or more processors, one or more programmable circuits, one or more dedicated circuits, or a combination thereof. Examples of the processors include, but are not limited to, general-purpose processors, such as a central processing unit (CPU) and a graphics processing unit (GPU) and a dedicated processor dedicated to particular processing. Examples of the programmable circuits include, but are not limited to, a field-programmable gate array (FPGA). Examples of the dedicated circuits include, but are not limited to, an ASIC (application-specific integrated circuit). An electronic control unit (ECU) mounted on the vehicle 10 may function as the control section 11. The control section 11 controls overall operation of the vehicle 10. The control section 11 may be capable of acquiring information indicating a remaining amount of electricity in the battery 14.

The storage section 12 includes one or more memories. Examples of the memories include, but are not limited to, a semiconductor memory, a magnetic memory, and an optical memory. Each of the memories included in the storage section 12 may function as, for example, a main storage device, an auxiliary storage device, or a cache memory. The storage section 12 stores arbitrary information to be used for operation of the vehicle 10. For example, the storage section 12 may store. e.g., a system program, an application program, and embedded software. Information stored in the storage section 12 may be, for example, information acquired from the network 30 via the communication section 13 and may be updatable.

The communication section 13 includes at least one communication interface. The communication interface is, for example, an interface complying with a mobile communication standard such as LTE, a 4G standard, or a 5G standard. For example, an in-vehicle communication instrument such as a data communication module (DCM) may function as the communication section 13. The communication section 13 receives information to be used for operation of the vehicle 10 and transmits information obtained by operation of the vehicle 10. In the present embodiment, the vehicle 10 communicates with the control apparatus 20 via the communication section 13 and the network 30.

The battery 14 is a secondary battery capable of repeating charge and discharge. The vehicle 10 is driven by electricity being supplied from the battery 14 to a motor, etc. The battery 14 may be, for example, a lead storage battery, a lithium-ion battery, or a nickel-hydrogen battery. The battery 14 is connected to a charging facility installed at an arbitrary spot, via a wire or wirelessly, and is charged with electricity.

The positioning section 15 includes at least one GNSS receiver. “GNSS” is an abbreviation for “global navigation satellite system”. The GNSS includes, for example, at least any of GPS, QZSS, BeiDou, GLONASS, and Galileo. “GPS” is an abbreviation for “Global Positioning System”. “QZSS” is an abbreviation for “Quasi-Zenith Satellite System”. A satellite of the QZSS is called “Quasi-Zenith satellite”. “GLONASS” is an abbreviation for “global navigation satellite system”. The positioning section 15 measures a position of the vehicle 10. A result of the measurement by the positioning section 15 is acquired by the control section 11 as position information of the vehicle 10. “Position information” is information that enables identification of a position of the vehicle 10, and includes, for example, coordinates of the vehicle 10.

As illustrated in FIG. 1, the control apparatus 20 includes a control section 21, a storage section 22, a communication section 23, an input section 24, and an output section 25.

The control section 21 includes one or more processors, one or more programmable circuits, one or more dedicated circuits, or a combination thereof. Examples of the processors include, but are not limited to, general-purpose processors such as a CPU and a GPU and a dedicated processor dedicated to particular processing. Examples of the dedicated circuits include, but are not limited to, an ASIC. The control section 21 controls overall operation of the control apparatus 20.

The storage section 22 includes one or more memories. Each of the memories included in the storage section 22 may function as, for example, a main storage device, an auxiliary storage device, or a cache memory. The storage section 22 stores arbitrary information to be used for operation of the control apparatus 20. For example, the storage section 22 may store, e.g., a system program, an application program, a database, and map information. Information stored in the storage section 22 may be, for example, information acquired from the network 30 via the communication section 23 and may be updatable.

The communication section 23 includes one or more communication interfaces connected to the network 30. The communication interface complies with, for example, but not limited to, a mobile communication standard, a wired LAN (local area network) standard, or a wireless LAN standard, and may comply with an arbitrary communication standard. In the present embodiment, the control apparatus 20 communicates with the vehicle 10 via the communication section 23 and the network 30.

The input section 24 includes at least one input interface. Examples of the input interface include a physical key, a capacitive key, a pointing device, a touch screen provided integrally with a display, and a microphone. The input section 24 receives an operation of inputting data to be used for operation of the control apparatus 20. The input section 24 may be connected to the control apparatus 20 as an external input instrument, instead of being included in the control apparatus 20. For a method of the connection, for example, an arbitrary method such as a USB, HDMI (registered trademark), or Bluetooth (registered trademark) may be used. “USB” is an abbreviation for Universal Serial Bus. “HDMI (registered trademark)” is an abbreviation for High-Definition Multimedia Interface.

The output section 25 includes at least one output interface. The output interface is, for example, a display or a speaker. The display is, for example, an LCD or an organic EL display. “LCD” is an abbreviation for “liquid crystal display”. “EL” is an abbreviation for “electroluminescence”. The output section 25 outputs data obtained by operation of the control apparatus 20. The output section 25 may be connected to the control apparatus 20 as an external output instrument, instead of being included in the control apparatus 20. For a method of the connection, for example, an arbitrary method such as USB, HDMI (registered trademark), or Bluetooth (registered trademark) may be used.

Functions of the control apparatus 20 are implemented by execution of a control program according to the present embodiment by a processor corresponding to the control section 21. In other words, the functions of the control apparatus 20 are implemented by software. The control program makes a computer function as the control apparatus 20 by making the computer execute operation of the control apparatus 20. In other words, a computer functions as the control apparatus 20 by executing operation of the control apparatus 20 according to the control program.

A program can be stored on a non-transitory computer-readable medium. The non-transitory computer-readable medium is an example of a storage medium. The non-transitory computer-readable medium is, for example, a magnetic recording device, an optical disc, a magnetooptical recording medium, or a ROM. A program is distributed by, for example, selling, assigning, or leasing a portable medium, such as a DVD or a CD-ROM, with the program stored thereon. “DVD” is an abbreviation for “digital versatile disc”. “CD-ROM” is an abbreviation for “compact disc read-only memory”. A program may be distributed by being stored in a storage of a server and then being transferred from the server to another computer. A program may be provided as a program product.

A computer temporarily stores, for example, a program stored on a portable medium or a program transferred from a server, in a main storage device. Then, the computer reads the program stored in the main storage device, via a processor and executes processing according to the read program via the processor. The computer may read the program directly from the portable medium and execute processing according to the program. Each time a program is transferred from a server to a computer, the computer may execute processing according to the received program. Processing may be executed via what is called an ASP-type service in which a function is implemented by providing an instruction for execution and acquiring a result alone without transferring a program from a server to a computer. “ASP” is an abbreviation for “application service provider”. Examples of the program include information that is provided for processing via an electronic computer and that is equivalent to a program. For example, data that is not a direct instruction for a computer but has a property of prescribing processing in a computer corresponds to one “that is equivalent to a program”.

The functions of the control apparatus 20 may partly or entirely implemented by a dedicated circuit corresponding to the control section 21. In other words, the functions of the control apparatus 20 may be partly or entirely implemented by hardware.

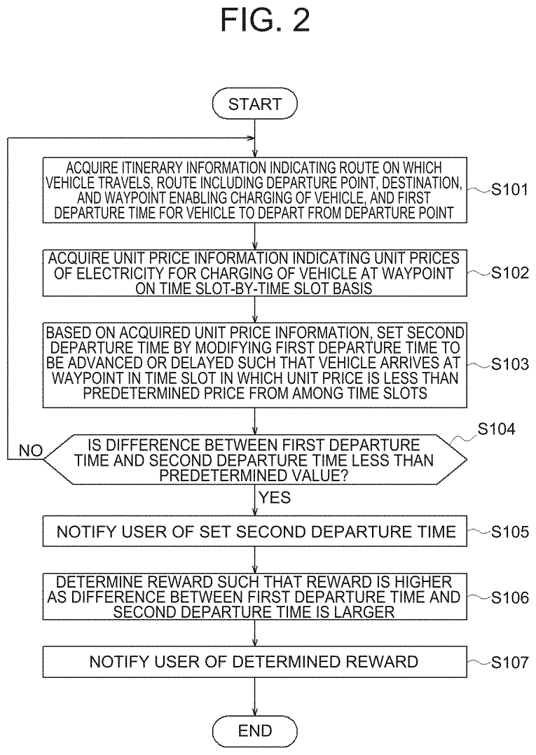

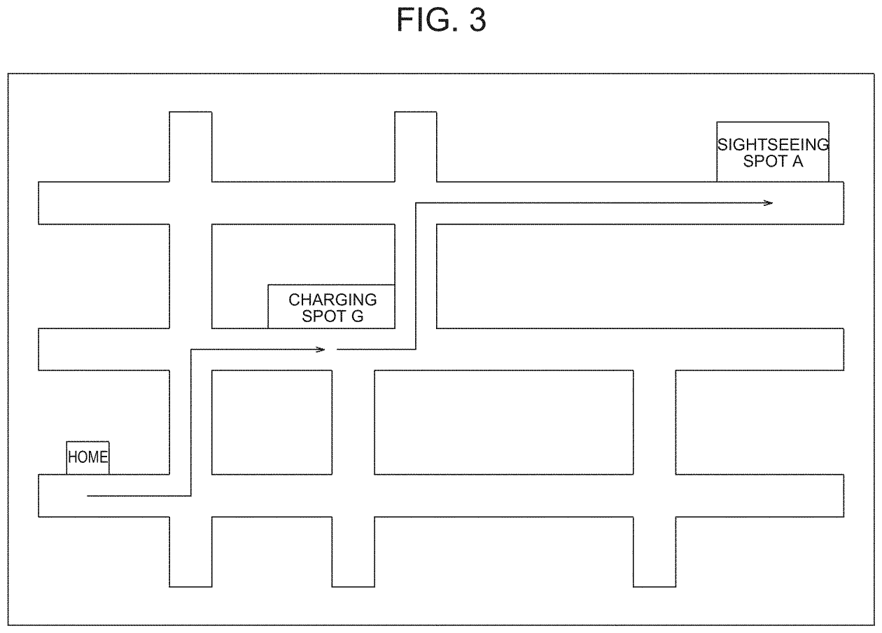

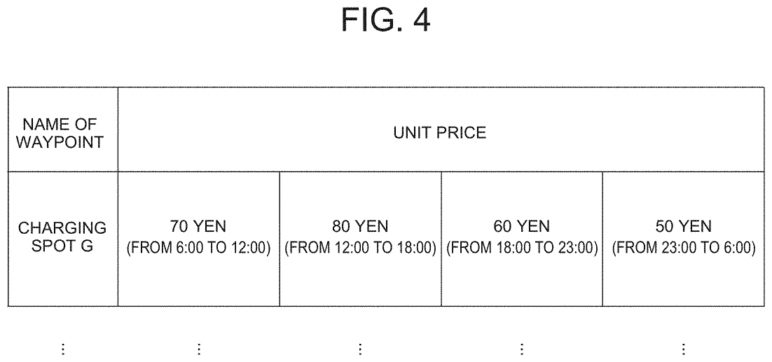

Operation of the control apparatus 20 according to the present embodiment will be described with reference to FIGS. 2, 3 and 4. The operation corresponds to a method according to the present embodiment. FIG. 2 is a flowchart illustrating operation of the control apparatus 20. FIG. 3 is a diagram for describing a route included in itinerary information. FIG. 4 is a diagram illustrating an example of unit price information. In the below, the control apparatus 20 transmits and receives information to an external apparatus via the communication section 23 and the network 30.

In step S101 in FIG. 2, the control section 21 acquires itinerary information indicating a route on which the vehicle 10 travels, the route including a departure point, a destination, and a waypoint that enables charging of the vehicle 10, and a first departure time for the vehicle 10 to depart from the departure point.

For acquisition of the itinerary information, an arbitrary method can be employed. For example, the control section 21 acquires the itinerary information through communication with the terminal device the user uses. More specifically, the control section 21 communicates with the terminal device the user uses, and receives information indicating a departure point, a destination, and a departure time input to the terminal device by the user. Based on the information, the control section 21 determines a shortest distance route from the departure point to the destination. A condition for route determination is not limited to a shortest distance but may arbitrarily be set. The control section 21 determines at least one arbitrary waypoint on the route. The control section 21 determines the received departure time as a first departure time. The control section 21 generates itinerary information including the received departure point and destination, and the determined waypoint and first departure time to acquire the itinerary information. The acquisition of the itinerary information is not limited to this example and the control apparatus 20 may acquire itinerary information from an external apparatus.

For determination of the waypoint, an arbitrary method may be employed. For example, the control section 21 may communicate with the vehicle 10 and acquire information indicating a remaining amount of electricity in the battery 14 from the vehicle 10, and based on the information, determines the waypoint. More specifically, the control section 21 calculates a distance the vehicle 10 can travel with the remaining electricity amount indicated by the information. The control section 21 may specify a spot within a range of the calculated distance from among spots each equipped with a charging facility present on the route and determine the spot as the waypoint. The information indicating the remaining amount of electricity in the battery 14 may constantly be transmitted from the vehicle 10 to the control apparatus 20.

The itinerary information acquired by the control section 21 in the present example includes the user's home, which is the departure point, sightseeing spot A, which is the destination, and charging spot G, which is the waypoint. It is assumed that the first departure time is 8:00 on Friday, Jul. 1, 2021. FIG. 3 indicates an example of the route included in the itinerary information in the present example. In FIG. 3, an example of a route for the vehicle 10 to travel from the home to sightseeing spot A via charging spot G is indicated by arrows.

In step S102, the control section 21 acquires unit price information indicating unit prices of electricity for charging of the vehicle 10 at the waypoint on a time slot-by-time slot basis.

The unit price information is information indicating unit prices of electricity to be supplied from a charging facility at the waypoint on a time slot-by-time slot basis. A unit price of electricity is, for example, a price per 1 kWh when electricity is supplied to the vehicle 10. The unit price may be determined by, e.g., an electric power company or a company that manages the charging facility at the waypoint. FIG. 4 indicates the unit price information in the present example. Referring to FIG. 4, unit prices of electricity at charging spot G are 70 yen from 6:00 to 12:00, 80 yen from 12:00 to 18:00, 60 yen from 18:00 to 23:00, and 50 yen from 23:00 to 6:00.

For acquisition of the unit price information, an arbitrary method can be employed. For example, the control section 21 may communicate with an external apparatus, constantly acquire latest unit price information at the waypoint, and store the latest unit price information in the storage section 22. The unit price information may periodically be updated.

In step S103, based on the unit price information acquired in step S102, the control section 21 sets a second departure time by modifying a first departure time to be advanced or delayed such that the vehicle 10 arrives at the waypoint in a time slot in which the unit price is less than a predetermined price from among the time slots.

The “predetermined price” may arbitrarily be set. The predetermined price may be, for example, a value that is less than an average price of a plurality of waypoints each equipped with a charging facility or may be a value set in advance by the user. In the present example, it is assumed that the predetermined price is 70 yen.

Referring to the unit price information in FIG. 4, slots in which the unit price is less than 70 yen are the time slot of 18:00 to 23:00 and the time slot of 23:00 to 6:00. Therefore, the control section 21 sets a second departure time by modifying the first departure time that is 8:00 on Friday, Jul. 1, 2021 such that the vehicle 10 arrives at charging spot G in either the time slot of 18:00 to 23:00 or the time slot of 23:00 to 6:00.

The control section 21 may set the second departure time according to an arbitrary method. For example, the control section 21 may acquire an average travel speed of the vehicle 10 from a past travel history of the vehicle 10, calculate a departure time that enables the vehicle 10 to arrive in a target time slot if the vehicle 10 travels on the route at the acquired speed, and set the departure time as a second departure time. The control section 21 may further acquire information indicating a traffic congestion condition on the route and set a second departure time in consideration of the traffic congestion condition indicated by the information.

The control section 21 may determine advancing or delaying the departure time in advance, based on the user's wish. More specifically, the control section 21 may communicate with the terminal device the user uses, and ask the user via the terminal device about whether the user wishes to advance or delay the departure time if the departure time is changed. The control section 21 receives information indicating an answer input to the terminal device by the user and stores the user's wish in the storage section 22. Consequently, the user can easily make an action plan while reflecting the user's preference.

For example, it is assumed that the user does not wish to arrive at the destination later than that in the case of a departure at the first departure time. In this case, the user can give an answer that the user wishes to advance the departure time if the departure time is changed.

Also, for example, it is assumed that the user does not wish to depart earlier than the first departure time because the user has already another plan such as a task until the first departure time. In this case, the user can give an answer that the user wishes to delay the departure time if the departure time is changed.

If there is no user's wish, the control section 21 may calculate a difference between the first departure time and the second departure time, for each of the method in which the departure time is advanced and the method in which the departure time is delayed, and set the second departure time of the method, the difference of which is smaller.

The control section 21 may determine whether the first departure time is advanced or delayed, in advance based on whether or not the departure point included in the itinerary information is the home or a place the user is visiting such as a sightseeing spot. For example, if the departure point of the itinerary information is the home and the destination is a sightseeing spot, that is, if a departure time of an outward journey is set, the control section 21 makes a determination to set the second departure time by advancing the first departure time. Consequently, it is possible to determine the second departure time that enables the user to arrive at the sightseeing spot that is the destination early.

On the other hand, for example, if the departure point is the sightseeing spot and the destination is the home, that is, if a departure time of a homeward journey is set, the control section 21 makes a determination to set the second departure time by delaying the first departure time. Consequently, it is possible to determine a second departure time that enables the user to arrive at the home that is the destination with some time allowance with no need for making a hasty departure from the visiting sightseeing spot.

Furthermore, the control section 21 may set a departure time that enables the vehicle 10 to arrive at the waypoint at an earliest time or a latest time in the target time slot, as the second departure time. When the user wishes to advance the departure time if the departure time is changed or when the departure point is the home, the control section 21 may set a departure time that enables the vehicle 10 to arrive at the waypoint at a latest time in the target time slot, as the second departure time.

Alternatively, when the user wishes to delay the departure time if the departure time is changed or when the departure point is a sightseeing spot, the control section 21 may set a departure time that enables the vehicle 10 to arrive at the waypoint at an earliest time in the target time slot, as a second departure time.

In the present example, it is assumed that the user wishes the departure time to be delayed if the departure time is changed. Therefore, the control section 21 sets a second departure time such that the vehicle 10 arrives at the waypoint in an earliest time in a time slot that is later than the first departure time from among the target time slots indicated in the unit price information.

The control section 21 sets a second departure time by modifying the first departure time to be delayed such that the vehicle 10 arrives at charging spot G at 18:00 on Jul. 1, 2021, which is an earliest time in the time slot of 18:00 to 23:00 in which the unit price of electricity at charging spot G is 60 yen or 23:00 on Jul. 1, 2021, which is an earliest time in the time slot of 23:00 to 6:00 in which the unit price is 50 yen. In the present example, it is assumed that a second departure time of a case where a setting is made such that the vehicle 10 arrives at charging spot G at 18:00 on Jul. 1, 2021 is 13:00 on Jul. 1, 2021. On the other hand, it is assumed that a second departure time of a case where a setting is made such that the vehicle 10 arrives at spot A at 23:00 on Jul. 1, 2021 is 19:00 on Jul. 1, 2021. The control section 21 stores the set second departure times in the storage section 22.

In step S104, the control section 21 sets a second departure time based on whether or not a difference between the first departure time and the second departure time is less than a predetermined value.

The predetermined value may arbitrarily be set. For example, the control section 21 may acquire a value input to the terminal device by the user as a limit of change of the departure time and set the value as the predetermined value. In the present example, it is assumed that the predetermined value is 6 hours. If the difference between the first departure time and the second departure time is not less than the predetermined value, the control section 21 does not set the second departure time and the processing returns to step S101. If the difference between the first departure time and the second departure time is less than the predetermined value, the processing in the control section 21 proceeds to step S105.

In the present example, first, the control section 21 reads the second departure times set in step S103 from the storage section 22. The control section 21 calculates a difference between 8:00 on Jul. 1, 2021, which is the first departure time, and 13:00 on Jul. 1, 2021, which is a second departure time, as 5 hours. Also, the control section 21 calculates a difference between the first departure time and 19:00 on Jul. 1, 2021, which is a second departure time, as 11 hours. Therefore, the control section 21 sets 13:00 on Jul. 1, 2021, which allows the difference between the first departure time and the second departure time to be less than the predetermined value, as a second departure time.

As indicated in steps S102 to S104, based on the itinerary information, the control section 21 sets a second departure time resulting from the first departure time being modified such that a time of arrival of the vehicle 10 at the waypoint becomes a predetermined time.

In step S105, the control section 21 notifies the user of the set second departure time.

The notification of the set second departure time may be performed via an arbitrary method. For example, the control section 21 may transmit information indicating the second departure time to the terminal device held by the user. In this case, the terminal device receives the information and notifies the user of the second departure time via an image or voice. In this way, the control section 21 can propose the second departure time to the user.

In step S106, the control section 21 determines a reward such that the reward is higher as the difference between the first departure time and the second departure time is larger.

Examples of the “reward” include, e.g., a discount ticket the user can use in a facility at the destination and a qualification of participation in an event that takes place at the destination in a game using position information of the user. Examples of the “reward” are not limited to these examples and may include an arbitrary one. In the present example, it is assumed that for each increase of one hour in difference between the first departure time and the second departure time, a discount rate of a discount ticket the user can use in a facility at the destination is increased by one percent. Examples of the facility at the destination include, e.g., a retail store and a restaurant.

Since the difference between the first departure time and the second departure time, the difference being determined in step S104, is 5 hours, the control section 21 determines a discount rate of a discount ticket the user can used at the destination as 5 percent. In this way, the control section 21 determines the reward such that the reward is higher as the difference between the first departure time and the second departure time is larger.

The control section 21 determines the reward when the vehicle 10 has departed at the second departure time. For detection of the departure of the vehicle 10 at the second departure time, an arbitrary method may be employed. For example, the control section 21 may communicate with the vehicle 10 and acquire position information indicating a position of the vehicle 10, the position being measured by the positioning section 15 of the vehicle 10, and based on the position information, detect that the vehicle 10 has departed at the second departure time.

As indicated in step S106, the control section 21 determines a reward provided to the user of the vehicle 10 if the vehicle 10 has departed at the set second departure time.

In step S107, the control section 21 notifies the user of the reward determined in step S106. Subsequently, the process ends.

For the notification of the reward to the user, an arbitrary method may be employed. For example, the control section 21 may transmit information indicating the reward to the terminal device held by the user. In this case, the terminal device receives the information and notifies the user of the reward via an image or voice. The control section 21 may notify the user of the reward when the vehicle 10 has arrived at the destination.

As described above, the control apparatus 20 according to the present embodiment includes the control section 21 that acquires itinerary information including a route on which the vehicle 10 travels, the route including a departure point, a destination, and a waypoint that enables charging of the vehicle 10, and a first departure time for the vehicle 10 to depart from the departure point, and based on the itinerary information, sets a second departure time resulting from the first departure time being modified such that a time of arrival of the vehicle 10 at the waypoint becomes a predetermined time.

The present embodiment enables the control section 21 to propose a modified departure time to the user as a second departure time in consideration of a timing for the vehicle 10 to be charged with electricity in the course of travel. The control section 21 can set a timing for the vehicle 10 to be charged with electricity such that the timing falls within a particular time slot such as a time slot in which a unit price of electricity is low. Departure of the vehicle 10 at the proposed departure time enables urging use of energy in the particular time slot. Therefore, it is possible to improve a technique relating to a plan for replenishment of energy for the vehicle 10.

As described above, in the control apparatus 20 according to the present embodiment, the control section 21 acquires unit price information indicating unit prices of electricity for charging of the vehicle 10 at the waypoint on a time slot-by-time slot basis, and based on the unit price information, sets a second departure time by modifying the first departure time to be advanced or delayed such that the vehicle 10 arrives at the waypoint in a time slot, the unit price for the time slot being less than a predetermined price, from among the time slots.

The present embodiment enables the control section 21 to set a second departure time such that the vehicle 10 is charged with electricity in a time slot, the unit price of electricity for the time slot being less than a predetermined price, and propose the second departure time to the user. The user recognizes that the vehicle 10 can be charged with electricity at a low price at the waypoint, and thus, the user can voluntarily depart at the proposed second departure time. Therefore, it is possible to improve a technique relating to a plan for replenishment of energy for the vehicle 10.

As described above, in the control apparatus 20 according to the present embodiment, the control section 21 sets a second departure time based on whether or not a difference between the first departure time and the second departure time is less than a predetermined value.

According to the present embodiment, the difference of the second departure time proposed to the user from the first departure time becomes small. Since an amount of change in departure time is small, the user can voluntarily depart at the proposed second departure time. Therefore, it is possible to improve a technique relating to a plan for replenishment of energy for the vehicle 10.

As described above, in the control apparatus 20 according to the present embodiment, the control section 21 determines a reward provided to the user of the vehicle 10 if the vehicle 10 has departed at the set second departure time.

According to the present embodiment, a reward is provided to the user if the vehicle 10 has departed at the proposed second departure time, and thus, the user can voluntarily depart at the proposed second departure time. Therefore, it is possible to improve a technique that proposes energy charging of the vehicle 10.

As described above, in the control apparatus 20 according to the present embodiment, the control section 21 determines the reward such that the reward is higher as the difference between the first departure time and the second departure time is larger.

The present embodiment enables obtaining a higher reward as the difference between the first departure time and the second departure time is larger, and thus, the user can voluntarily depart at the proposed second departure time even if an amount of change in departure time is large. Therefore, it is possible to improve a technique relating to a plan for replenishment of energy for the vehicle 10.

Although the disclosure has been described based on the drawings and embodiment, it should be noted that a person skilled in the art can make various modifications and alterations based on the present disclosure. Therefore, it should be noted that these modifications and alterations are embraced within the scope of the disclosure. For example, the functions and the like included in the component sections, the steps, or the like can be rearranged in such a manner as to cause no logical contradiction, and a plurality of component sections, steps, or the like can be combined into one or can be divided. For example, the above-described embodiment can be an embodiment in which the configuration and operation of the control apparatus 20 are distributed among a plurality of computers that can communicate with each other. Also, for example, the above-described embodiment can be an embodiment in which the components of the control apparatus 20 are partly or entirely provided in the vehicle 10.

### First Modification

Next, a first modification of the embodiment of the present disclosure will be described. In the present modification, a control section 21 acquires unit price information indicating unit prices of electricity for charging of a vehicle 10 at a waypoint on a time slot-by-time slot basis, and based on the unit price information, sets a second departure time by modifying a first departure time to be advanced or delayed such that the vehicle 10 arrives at the waypoint in a time slot in which the unit price is lowest among the time slots.

A configuration of a system 1 and configurations of respective apparatuses or devices according to the first modification are similar to those of the above-described embodiment, and thus, description thereof is omitted.

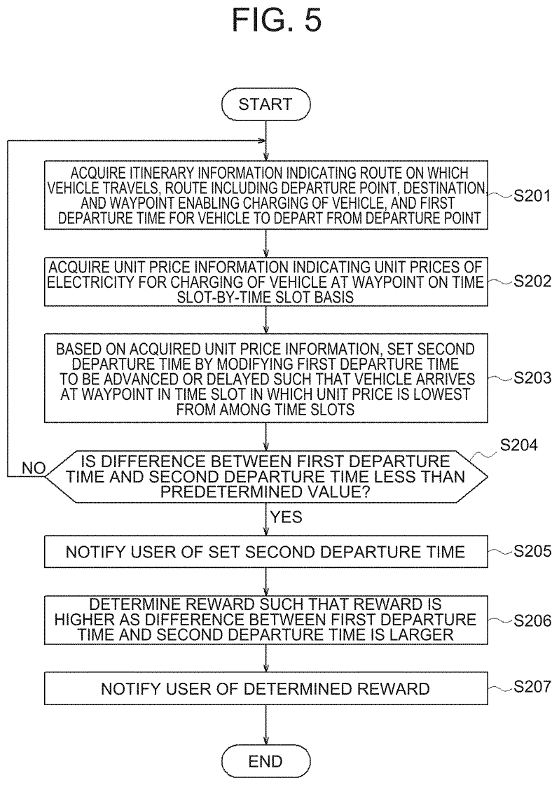

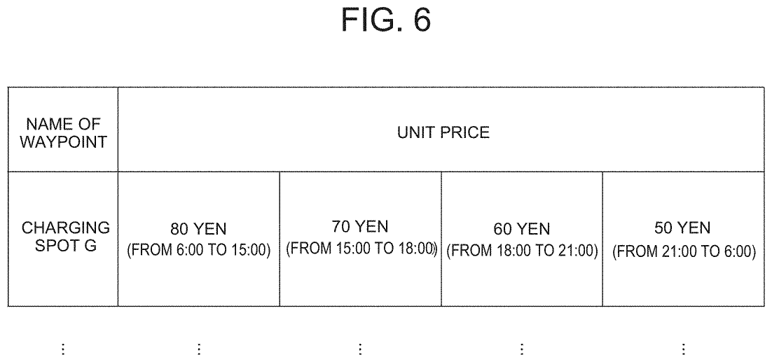

Differences between the operation of the control apparatus 20 according to the above-described embodiment and operation of a control apparatus 20 according to the present modification will be described below with reference to FIGS. 5 and 6.

Steps S201 and S202 in FIG. 5 are similar to steps S101 and S102 in FIG. 2 according to the above-described embodiment, and thus, description thereof is omitted.

In step S203 in FIG. 5, based on unit price information acquired in step S202, the control section 21 sets a second departure time by modifying a first departure time to be advanced or delayed such that the vehicle 10 arrives at a waypoint in a time slot in which the unit price is lowest among time slots.

FIG. 6 illustrates an example of the unit price information the control section 21 acquires in the present modification. Referring to FIG. 6, unit prices of electricity at charging spot G are 80 yen from 6:00 to 15:00, 70 yen from 15:00 to 18:00, 60 yen from 18:00 to 21:00, and 50 yen from 21:00 to 6:00. The control section 21 sets the second departure time by modifying the first departure time to be advanced or delayed such that the vehicle 10 arrives at the waypoint in the time slot of 21:00 to 6:00 in which the unit price is lowest.

For example, the control section 21 sets the second departure time as 16:00 on Jul. 1, 2021 such that the vehicle 10 arrives at the waypoint at 21:00 on Jul. 1, 2021, which is an earliest time in the relevant time slot. The control section 21 stores the set second departure time in the storage section 22.

In step S204, the control section 21 sets the second departure time based on whether or not a difference between the first departure time and the second departure time is less than a predetermined value.

If the difference between the first departure time and the second departure time is not less than the predetermined value, the control section 21 does not set the second departure time, and the processing returns to step S201. If the difference between the first departure time and the second departure time is less than the predetermined value, the processing in the control section 21 proceeds to Step S205.

In the present modification, it is assumed that the predetermined value is 12 hours. First, the control section 21 reads the second departure time set in step S203 from the storage section 22. The control section 21 calculates 8 hours, which is a difference between 8:00 on Jul. 1, 2021, which is the first departure time, and 16:00 on Jul. 1, 2021, which is the second departure time. Since the difference is less than the predetermined value, the control section 21 determines 16:00 on Jul. 1, 2021 as the second departure time.

Steps S205 to S207 in FIG. 5 are similar to steps S105 to S107 in FIG. 3 according to the above-described embodiment, and thus, description thereof is omitted.

As described above, in the control apparatus 20 according to the present modification, the control section 21 acquires unit price information indicating unit prices of electricity for charging of the vehicle 10 at a waypoint on a time slot-by-time slot basis, and based on the unit price information, sets a second departure time by modifying a first departure time to be advanced or delayed such that the vehicle 10 arrives at the waypoint in a time slot in which the unit price is lowest among the time slots.

The present modification enables the control section 21 to propose a second departure time to a user in such a manner as to arrive at a waypoint in a time slot in which a unit price of electricity is lowest. The user recognizes that a departure at the proposed second departure time enables travelling most economically, and thus, the user can voluntarily depart at the proposed second departure time. Therefore, it is possible to improve a technique relating to a plan for replenishment of energy for the vehicle 10.

### Second Modification

Next, a second modification of the embodiment of the present disclosure will be described. In the present modification, if itinerary information includes a plurality of waypoints, a control section 21 acquires pieces of waypoint unit price information indicating unit prices of electricity for charging of a vehicle 10 at each of the waypoints on a time slot-by-time slot basis. Based on the pieces of waypoint unit price information, the control section 21 specifies a waypoint that enables charging of the vehicle 10 at a lowest unit price from among the waypoints as a candidate waypoint, specifies a time slot in which the unit price is lowest at the waypoint as a candidate time slot, and sets a second departure time by modifying a first departure time to be advanced or delayed such that the vehicle 10 arrives at the candidate waypoint in the candidate time slot.

A configuration of a system 1 and configurations of respective apparatuses or devices according to the second modification are similar to those of the above-described embodiment, and thus, description thereof is omitted.

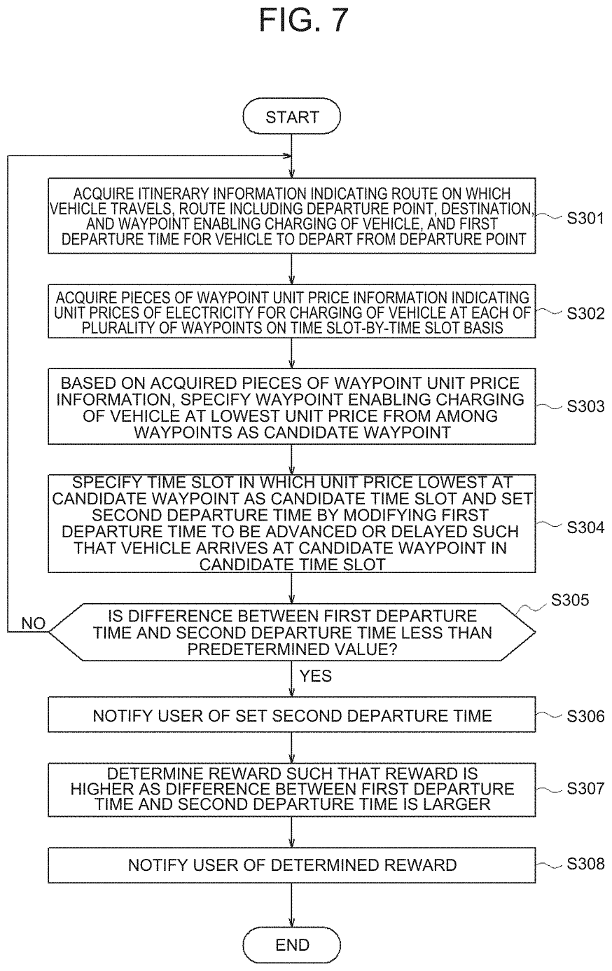

Differences between the operation of the system 1 according to the above-described embodiment and operation of the system 1 according to the present modification will be described below with reference to FIGS. 7 to 9.

In step S301, the control section 21 acquires itinerary information indicating a route on which the vehicle 10 travels, the route including a departure point, a destination, a waypoint that enables charging of the vehicle 10, and a first departure time for the vehicle 10 to depart from the departure point.

As in the above-described embodiment, for determination of the waypoint, an arbitrary method may be employed. For example, the control section 21 may communicate with the vehicle 10 and acquire information indicating a remaining amount of electricity in a battery 14 from the vehicle 10, and based on the information, determine a plurality of waypoints.

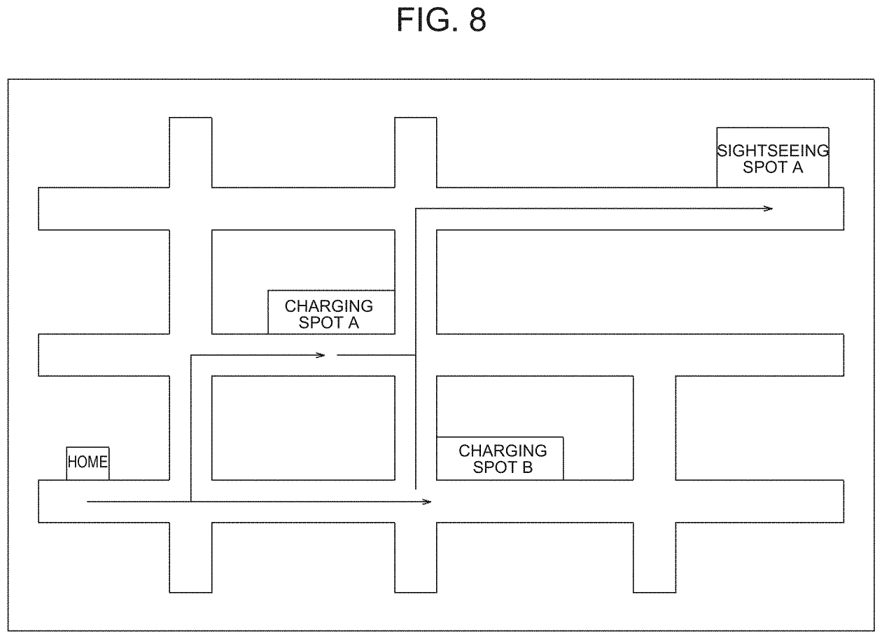

In the present modification, the itinerary information acquired by the control section 21 includes a home as a departure point, sightseeing spot A as a destination, and charging spot G and charging spot H as waypoints. A first departure time is 8:00 on Friday, Jul. 1, 2021. FIG. 8 illustrates an example of the route of the vehicle 10 included in the itinerary information in the present modification. As illustrated in FIG. 8, the route of the vehicle 10 is a route from the home to sightseeing spot A via charging spot G or charging spot H.

In step S302, the control section 21 acquires pieces of waypoint unit price information indicating unit prices of electricity for charging of the vehicle 10 at each of the waypoints on a time slot-by-time slot basis.

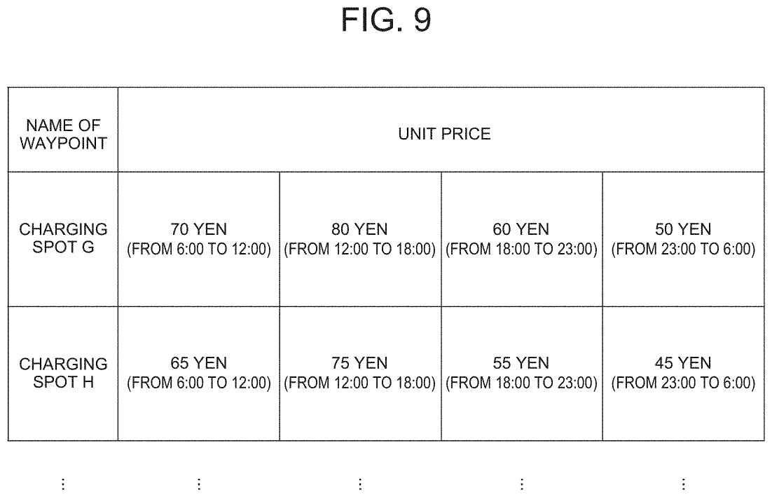

FIG. 9 illustrates an example of the pieces of waypoint unit price information in the present modification. Referring to FIG. 9, the unit prices of electricity at charging spot G are 70 yen from 6:00 to 12:00, 80 yen from 12:00 to 18:00, 60 yen from 18:00 to 23:00, and 50 yen from 23:00 to 6:00, per 1 kWh. Also, the unit prices of electricity at charging spot H are 65 yen from 6:00 to 12:00, 75 yen from 12:00 to 18:00, 55 yen from 18:00 to 23:00, and 45 yen from 23:00 to 6:00, per 1 kWh.

As in the above-described embodiment, for acquisition of the unit price information, an arbitrary method can be employed. For example, the control section 21 may communicate with an external apparatus, constantly acquire latest unit price information for each of the waypoints, and store the latest unit price information in the storage section 22 as pieces of waypoint unit price information. The pieces of waypoint unit price information may periodically be updated.

In step S303, based on the pieces of waypoint unit price information acquired in step S102, the control section 21 specifies a waypoint that enables charging of the vehicle 10 at a lowest unit price from among the waypoints as a candidate waypoint.

In the present modification, referring to FIG. 9, charging can be performed at a lowest unit price in the time slot of 23:00 to 6:00 at charging spot H from among charging spot G and charging spot H, which are the waypoints. Therefore, the control section 21 specifies charging spot H as a candidate waypoint.

In step S304, the control section 21 specifies a time slot in which the unit price is lowest at the candidate waypoint as a candidate time slot and sets a second departure time by modifying the first departure time to be advanced or delayed such that the vehicle 10 arrives at the candidate waypoint in the candidate time slot.

In the present modification, the control section 21 sets the second departure time by modifying the first departure time to be advanced or delayed such that the vehicle 10 arrives at charging spot H, which is a waypoint, in the time slot of 23:00 to 6:00 in which the unit price is lowest. For example, the control section 21 sets the second departure time as 19:00 on Jul. 1, 2021 such that the vehicle 10 arrives at charging spot H at 23:00 on Jul. 1, 2021, which is an earliest time in that time slot. The control section 21 stores the set second departure time in the storage section 22.

In step S305 in FIG. 7, the control section 21 sets the second departure time based on whether or not a difference between the first departure time and the second departure time is less than a predetermined value.

If the difference between the first departure time and the second departure time is not less than the predetermined value, the control section 21 does not set the second departure time and the processing returns to step S301. If the difference between the first departure time and the second departure time is less than the predetermined value, the processing in the control section 21 proceeds to step S306.

In the present modification, it is assumed that the predetermined value is 12 hours. First, the control section 21 reads the second departure time set in step S304 from the storage section 22. The control section 21 calculates a difference between 8:00 on Jul. 1, 2021, which is the first departure time, and 19:00 on Jul. 1, 2021, which is the second departure time, as 11 hours. Since the difference is less than the predetermined value, the control section 21 determines 19:00 on Jul. 1, 2021 as the second departure time.

Steps S306 to S308 in FIG. 7 are similar to steps S105 to S107 in FIG. 2 according to the above-described embodiment, and thus, description thereof is omitted.

As described above, in the control apparatus 20 according to the present modification, when itinerary information includes a plurality of waypoints, the control section 21 acquires pieces of waypoint unit price information indicating unit prices of electricity for charging of the vehicle 10 at each of the waypoints on a time slot-by-time slot basis, and based on the pieces of waypoint unit price information, specifies a waypoint that enables charging of the vehicle 10 at a lowest unit price from among the waypoints as a candidate waypoint, specifies a time slot in which the unit price is lowest at the candidate waypoint as a candidate time slot, and set a second departure time by modifying a first departure time to be advanced or delayed such that the vehicle 10 arrives at the candidate waypoint in the candidate time slot.

The present modification enables, even if a plurality of waypoints is included, setting a second departure time such that a vehicle 10 is charged with electricity in a time slot in which a unit price of electricity is a lowest price and proposing the second departure time to a user. The user recognizes that a departure at the proposed second departure time enables constantly travelling most economically, and thus, the user can voluntarily depart at the proposed second departure time. Therefore, it is possible to improve a technique relating to a plan for replenishment of energy for a vehicle 10.

### Third Modification

Next, a third modification of the embodiment of the present disclosure will be described. In the present modification, a control section 21 calculates a time at which a vehicle 10 arrives at a waypoint if the vehicle 10 departs at a first departure time, as a first expected arrival time. The control section 21 further calculates a time at which the vehicle 10 arrives at the waypoint if the vehicle 10 departs at a second departure time, as a second expected arrival time. The control section 21 determines a reward such that the reward is higher as a difference between a unit price of a time slot including the first expected arrival time and a unit price of a time slot including the second expected arrival time at the waypoint is larger.

A configuration of a system 1 and configurations of respective apparatuses or devices according to the third modification are similar to those of the above-described embodiment, and thus, description thereof is omitted.

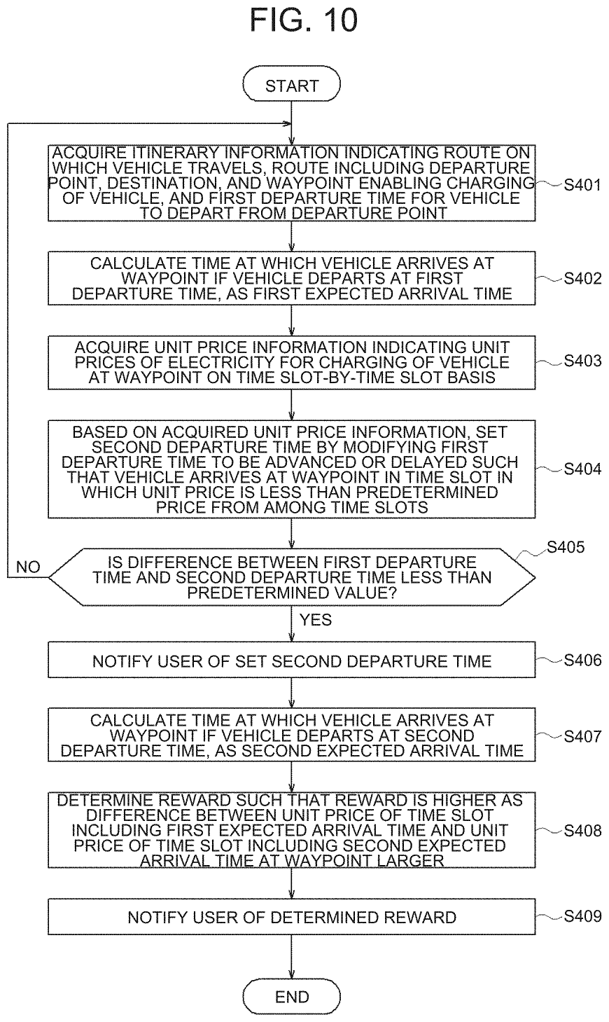

Differences between the operation of the system 1 according to the above-described embodiment and operation of a system 1 according to the present modification will be described below with reference to FIGS. 4 and 10.

Step S401 is similar to step S101 in FIG. 2 according to the above-described embodiment, and description thereof is omitted.

In step S402, the control section 21 calculates a time at which the vehicle 10 arrives at a waypoint if the vehicle 10 departs at a first departure time, as a first expected arrival time.

The calculation of the first expected arrival time may be performed via an arbitrary method. For example, the control section 21 may acquire an average travel speed of the vehicle 10 from a past travel history of the vehicle 10, and calculate a time at which the vehicle 10 arrives at the waypoint if the vehicle 10 travels on a route at the acquired speed, as a first expected arrival time. The control section 21 may further acquire information indicating a traffic congestion condition on the route and calculate a first expected arrival time of arrival at the waypoint in consideration of the traffic congestion condition indicated by the information. In the present example, the first departure time is 8:0) on Jul. 1, 2021. It is assumed that the control section 21 calculates an expected arrival time that is a first expected arrival time of arrival at charging spot G that is the waypoint, as 11:00.

Steps S403 to S406 are similar to steps S102 to S105 in FIG. 2 according to the above-described embodiment, and thus, description thereof is omitted.

In step S407, the control section 21 calculates a time at which the vehicle 10 arrives at the waypoint if the vehicle 10 departs at a second departure time, as a second expected arrival time.

The calculation of the second expected arrival time may be performed via an arbitrary method. For example, as with the first expected arrival time of the vehicle 10, the control section 21 may calculate a second expected arrival time based on the average travel speed of the vehicle 10. The control section 21 may further acquire information indicating a traffic congestion condition on the route, and calculate a second expected arrival time of arrival at the waypoint in consideration of the traffic congestion condition indicated by the information. For example, it is assumed that the second departure time set in step S405 is 13:00 on Jul. 1, 2021. The control section 21 calculates a second expected arrival time of arrival at charging spot G that is the waypoint, as 18:00.

In step S408, the control section 21 determines a reward such that the reward is higher as a difference between a unit price of a time slot including the first expected arrival time and a unit price of a time slot including the second expected arrival time at the waypoint is larger.

As in the above-described embodiment, the reward may include an arbitrary one. In the present modification, it is assumed that for each increase of the difference between the unit price of the time slot including the first expected arrival time and the unit price of the time slot including the second expected arrival time by one yen, a discount rate of a discount ticket the user can use in a facility at a destination increases by 0.5 percent. Referring to the unit price information indicated in FIG. 4, a unit price of electricity in a time slot including 11:00, which is the first expected arrival time, is 70 yen and a unit price of a time slot including 18:00, which is the second expected arrival time, is 60 yen at charging spot G. Since the difference between the unit prices is 10 yen, the control section 21 determines a discount rate of a discount ticket the user can use in a facility at the destination, as 5 percent. In this way, the control section 21 determines a reward such that the reward is higher as a difference between a unit price of a time slot including a first expected arrival time and a unit price of a time slot including a second expected arrival time is larger.

Step S409 is similar to step S107 in FIG. 2 according to the above-described embodiment, and thus, description thereof is omitted.

As described above, in the control apparatus 20 according to the present modification, the control section 21 calculates a time at which the vehicle 10 arrives at a waypoint if the vehicle 10 departs at a first departure time, as a first expected arrival time, calculates a time at which the vehicle 10 arrives at the waypoint if the vehicle 10 departs at a second departure time, as a second expected arrival time, and determines a reward such that the reward is higher as a difference between a unit price of a time slot including the first expected arrival time and a unit price of a time slot including the second expected arrival time at the waypoint is larger.

According to the present modification, as a difference in unit price of electricity between a departure at a first departure time and a departure at a second departure time is larger, a higher reward is provided to a user. The user recognizes that as the unit price of electricity is further lowered relative to the initially expected, the reward becomes higher, and thus, the user can voluntarily depart at the proposed second departure time. Therefore, it is possible to improve a technique relating to a plan for replenishment of energy for a vehicle 10.

What is claimed is:

1. A control apparatus comprising a control section that
acquires itinerary information indicating a route on which a vehicle travels, the route including a departure point, a destination, and a waypoint that enables charging of the vehicle, and a first departure time for the vehicle to depart from the departure point, and
based on the itinerary information, sets a second departure time resulting from the first departure time being modified such that a time of arrival of the vehicle at the waypoint becomes a predetermined time.

2. The control apparatus according to claim 1, wherein
the control section acquires unit price information indicating unit pieces of electricity for charging of the vehicle at the waypoint on a time slot-by-time slot basis; and
based on the unit price information, the control section sets the second departure time by modifying the first departure time to be advanced or delayed such that the vehicle arrives at the waypoint in a time slot in which the unit price is less than a predetermined price from among the time slots.

3. The control apparatus according to claim 1, wherein:
the control section acquires unit price information indicating unit prices of electricity for charging of the vehicle at the waypoint on a time slot-by-time slot basis; and
based on the unit price information, the control section sets the second departure time by modifying the first departure time to be advanced or delayed such that the vehicle arrives at the waypoint in a time slot in which the unit price is lowest from among the time slots.

4. The control apparatus according to claim 1, wherein the control section sets the second departure time based on whether or not a difference between the first departure time and the second departure time is less than a predetermined value.

5. The control apparatus according to claim 1, wherein:
when the itinerary information includes a plurality of the waypoints, the control section acquires pieces of waypoint unit price information indicating unit prices of electricity for charging of the vehicle at each of the waypoints on a time slot-by-time slot basis;
based on the pieces of waypoint unit price information, the control section specifies a waypoint that enables charging of the vehicle at the unit price that is lowest from among the waypoints, as a candidate waypoint;
the control section specifies a time slot in which the unit price is lowest at the candidate waypoint, as a candidate time slot; and
the control section sets the second departure time by modifying the first departure time to be advanced or delayed such that the vehicle arrives at the candidate waypoint in the candidate time slot.

6. The control apparatus according to claim 1, wherein the control section determines a reward provided to a user of the vehicle when the vehicle has departed at the set second departure time.

7. The control apparatus according to claim 6, wherein the control section determines the reward such that the reward is higher as a difference between the first departure time and the second departure time is larger.

8. The control apparatus according to claim 6, wherein:
the control section calculates a time at which the vehicle arrives at the waypoint when the vehicle departs at the first departure time, as a first expected arrival time:
the control section calculates a time at which the vehicle arrives at the waypoint when the vehicle departs at the second departure time, as a second expected arrival time; and
the control section determines the reward such that the reward is higher as a difference between a unit price of a time slot including the first expected arrival time and a unit price of a time slot including the second expected arrival time at the waypoint is larger.

9. A method comprising:
acquiring itinerary information indicating a route on which a vehicle travels, the route including a departure point, a destination, and a waypoint that enables charging of the vehicle, and a first departure time for the vehicle to depart from the departure point, and
based on the itinerary information, setting a second departure time resulting from the first departure time being modified such that a time of arrival of the vehicle at the waypoint becomes a predetermined time.

10. The method according to claim 9, further comprising:
acquiring unit price information indicating unit prices of electricity for charging of the vehicle at the waypoint on a time slot-by-time slot basis; and
based on the unit price information, setting the second departure time by modifying the first departure time to be advanced or delayed such that the vehicle arrives at the waypoint in a time slot in which the unit price is less than a predetermined price from among the time slots.

11. The method according to claim 9, further comprising:
acquiring unit price information indicating unit prices of electricity for charging of the vehicle at the waypoint on a time slot-by-time slot basis; and
based on the unit price information, setting the second departure time by modifying the first departure time to be advanced or delayed such that the vehicle arrives at the waypoint in a time slot in which the unit price is lowest from among the time slots.

12. The method according to claim 9, further comprising setting the second departure time based on whether or not a difference between the first departure time and the second departure time is less than a predetermined value.

13. The method according to claim 9, further comprising determining a reward provided to the user of the vehicle when the vehicle has departed at the set second departure time.

14. The method according to claim 13, further comprising determining the reward such that the reward is higher as a difference between the first departure time and the second departure time is larger.

15. A non-transitory storage medium storing a program for making a computer execute an operation including:
acquiring itinerary information indicating a route on which a vehicle travels, the route including a departure point, a destination, and a waypoint that enables charging of the vehicle, and a first departure time for the vehicle to depart from the departure point, and
based on the itinerary information, setting a second departure time resulting from the first departure time being modified such that a time of arrival of the vehicle at the waypoint becomes a predetermined time.

16. The storage medium according to claim 15, wherein the operation further includes:
acquiring unit price information indicating unit pieces of electricity for charging of the vehicle at the waypoint on a time slot-by-time slot basis; and
based on the unit price information, setting the second departure time by modifying the first departure time to be advanced or delayed such that the vehicle arrives at the waypoint in a time slot in which the unit price is less than a predetermined price from among the time slots.

17. The storage medium according to claim 15, wherein the operation further includes:
acquiring unit price information indicating unit prices of electricity for charging of the vehicle at the waypoint on a time slot-by-time slot basis; and
based on the unit price information, setting the second departure time by modifying the first departure time to be advanced or delayed such that the vehicle arrives at the waypoint in a time slot in which the unit price is lowest from among the time slots.

18. The storage medium according to claim 15, wherein the operation further includes setting the second departure time based on whether or not a difference between the first departure time and the second departure time is less than a predetermined value.

19. The storage medium according to claim 15, wherein the operation further includes determining a reward provided to a user of the vehicle when the vehicle has departed at the set second departure time.

20. The storage medium according to claim 19, wherein the operation further includes determining the reward such that the reward is higher as a difference between the first departure time and the second departure time is larger.
